(19) United States
(12) Patent Application Publication
(10) Pub. No.: US 2026/0254895 A1
(43) Pub. Date: Aug. 27, 2026

(54) CALLING LINE IDENTIFICATION DISPLAY CONTROL USING NUMBER MANAGEMENT TECHNOLOGY FOR WIRELESS SERVICES

(71) Applicant: Skytell AG, Zug (CH)

(72) Inventor: Felix Vakhovsky, Miami, FL (US)

(73) Assignee: Skytell AG, Zug (CH)

(21) Appl. No.: 19/061,587

(22) Filed: Feb. 24, 2025

(51) Int. Cl. H04M 3/42; H04W 8/26

(52) U.S. Cl. CPC H04M 3/42059; H04W 8/26

(57) ABSTRACT

A calling line identification display control system or method interacts with a multinumbers control point can include a user interface enabling a subscriber to independently select and configure which MSISDNs will be displayed to a called party during phone calls or SMS message(s). The method in a standard mode can include always displaying a primary number on a display of the called party when the subscriber makes outgoing calls/SMS messages to any MSISDN in any country and when the subscriber has purchased only the primary number. When the subscriber has multiple MSISDNs in different countries, the system displays a local number (MSISDN) of a receiving country on the display of the called party. When the subscriber makes outgoing calls/SMS messages to MSISDNs in countries not on a list of numbers purchased, the system displays a default number subscriber selected as the primary number on the display of the called party.

### CROSS-REFERENCE TO RELATED APPLICATIONS

U.S. application Ser. No. 18/891,576 filed on Sep. 20, 2024 entitled “Multinumbers Technology For Wireless Services”.

### TECHNICAL FIELD

The present disclosure generally relates to mobile station international subscriber directory number systems. More particularly, but not exclusively, the present disclosure relates to apparatus, systems, and methods that enables easy management of display control of calling line identification of many different local and international phone numbers such as Mobile Station Integrated Services Digital Numbers (MSISDNs) that can be assigned to a single subscriber identity module SIM or eSIM.

### BACKGROUND

A mobile station international subscriber directory number (MSISDN) identifies a mobile subscriber and is used as a caller identification number when a phone call is placed from the mobile device. When a first user wants to call another mobile device user, the first user dials an MSISDN of the other party.

A single MSISDNs can be sent in this manner via a voice communication network, an short messaging service (SMS) network, a multimedia message service (MMS) network, or almost any other wired or wireless network. SMS and MMS networks are similar, but an SMS network is only capable of sending text whereas an MMS network can send multimedia content such as pictures, video, and audio in addition to text. Using MMS does require additional network infrastructure to process the additional data resulting from transmitting pictures, video and audio and typically requires an internet connection whereas an SMS text message does not. Typically, the internet connection for an MMS message is provided through cellular data networks.

With respect to MSISDNs, it is a technical term sometimes used for the mobile number attached to a SIM card or eSIM in a mobile phone. An MSISDN contains several significant digits to identify country, destination, and subscriber number. Depending on the country, the MSISDN can generally be broken down like this:

MSISDN=CC+NDC+SN, where CC=Country Code, NDC=National Destination Code and SN=Subscriber Number.

In countries like the USA, an NDC is used to identify a specific region within the country, but some countries do not use an NDC. When sending SMS via SMPP, the number must be provided in full international format in order to deliver to the GSM network correctly. Many usability problems can surround this as a large proportion of mobile subscribers are not aware of specific country codes.

Notwithstanding the above, existing systems fail to provide ease of use and flexibility in a manner that is efficient and cost effective for both users and providers.

A glossary follows defining the terms and acronymns used in the industry and in this disclosure:
API is an Application Program Interface, which is a software intermediarty that allows different software systems “to talk” to each other.
CLI is a Calling Line Identification by MSISDN to be provided to the receiving or called party.
Country Code is the first 1-3 digits of the MSISDN indicating the country to which the MSISDN belongs.
DID Provider is an operator that leases the MSISDN of various countries.
IMSI International Mobile Subscriber Identity.
Home Network Operator is the operator of the Home Network.
Home MSISDN is the MSISDN belonging to the Home Network Operator.
HLR Home Location Register.
GMSC is a Gateway Mobile Switching Center which is a type of Mobile Switching Center (MSC) that is used to route calls outside the mobile network. Mobile Switching Center Servers (MSC-S) provide control of high capacity swithching in mobile circuit core networks for operators to control services and switching.
MSISDN means the Mobile Station Integrated Services Digital Number or the Subscriber's mobile number of a digital network with integrated services for communication in GSM, UMTS and other standards.
SIM means Subscriber Identification Module.
SMSC Short Message Service Center.
SBC is a session border controller is a dedicated hardware device or software application that governs the manner in which phone calls are initiated, conducted and terminated on a voice over Internet Protocol (VoIP) network. Phone calls are referred to as sessions. Note that a gateway mainly provides conversion between a circuit based interface and a packet based service while a SBC is the border between two packet-based networks. In a nutshell, SBCs play unique roles in a VoIP system and are indispensible for a well-fuctioning IP communication system.

### SUMMARY

In some embodiments, a calling line identification display control system that interacts with a multinumbers control point in a home network and further having one or more subscriber phone numbers stored on a memory of the multinumbers control point can include a user interface enabling a subscriber to independently select and configure which Mobile Station Integrated Services Digital Number (MSISDNs) will be displayed to a called party during a phone call or a short messaging system (SMS) calls and one or more processors coupled to the memory having computer instructions where the one or more processors are configured to execute computer instructions to perform certain operations. In some embodiments, the operations can include always displaying a primary number on the display of the called party when the subscriber makes outgoing calls or sends SMS messages to any MSISDN in any country and when the subscriber has purchased only the primary number. In some embodiments, when the subscriber makes outgoing calls or sends SMS messages and when the subscriber has multiple MSISDNs in different countries that were purchased, displaying a local number (MSISDN) of a receiving country on the display of the called party. In some embodiments, when the subscriber makes outgoing calls or sends SMS messages to MSISDNs in countries not on a list of numbers purchased by the subscriber, displaying a default number of a country that the subscriber selected as the primary number on the display of the called party.

In some embodiments, the one or more processors are further configured to enable the subscriber to independently choose among several MSISDNs for a single country for display at the display of the called party when the subscriber calls the called party in the single country.

In some embodiments, the user interface provides the user with a selection icon for each of the several MSISDNs for the single country from which to choose from.

In some embodiments, the system displays at the display of the called party a chosen MSISDN for the single country when the subscriber makes a phone call or sends an SMS to a country for which the subscriber did not purchase an MSISDN.

In some embodiments, there can only be one selected country activated in the user interface.

In some embodiments, the the subscriber in an advanced mode can select any MSISDN from a list of purchased MSISDNs when making an outgoing call or sending an SMS message to any country.

In some embodiments, the subscriber can remotely select their preference of MSISDN for display when making an outgoing call or sending an SMS message by contacting a call center.

In some embodiments, the subscriber can remotely select their preference of MSISDN for display when making an outgoing call or sending an SMS message by contacting a call center that has access via an application program interface to a billing system and wherein all MSISDNs purchased by the subscriber is stored in a database for the billing system or a separate database.

In some embodiments, the subscriber chooses a preferred MSISDN from a list of purchased MSISDNs to be displayed on the screen of the called party and wherein information about the selected preferred MSISDN is transmitted as an attribute from a mobile application or a Personal Account via a network and via API to the selected billing database, as well as to the multinumbers control point.

In some embodiments, a selected billing database and the multinumber control point log selected MSISDN(s) made by the subscriber as number attributes and wherein while a connection is being established or when an SMS is being sent, the multinumber control point analyzes the number attributes for the MSISDN and the corresponding calling line identification (CLI) numbers are transmitted based on the number attributes and multinumber control point logic. The multinumber control point logic can be algorithms programmed or set in or for the multinumber control point.

In some embodiments, a method for calling line identification display control that interacts with a multinumbers control point in a home network and where one or more subscriber phone numbers are stored on a memory of the multinumbers control point include certain steps. The steps can include presenting a user interface enabling a subscriber to independently select and configure which Mobile Station Integrated Services Digital Number (MSISDNs) will be displayed to a called party during a phone call or during the sending of short messaging system (SMS) messages, and always displaying a primary number on the display of the called party when the subscriber makes outgoing calls or sends SMS messages to any MSISDN in any country and when the subscriber has purchased only the primary number. The method can further include displaying a local number (MSISDN) of a receiving country on the display of the called party when the subscriber makes outgoing calls or sends SMS messages and when the subscriber has multiple MSISDNs in different countries that were purchased and further displaying a default number of a country that the subscriber selected as the primary number on the display of the called party when the subscriber makes outgoing calls or sends SMS messages to MSISDNs in countries not on a list of numbers purchased by the subscriber.

In some embodiments, the method further includes the step of configuring the user interface to enable the subscriber to independently choose among several MSISDNs for a single country for display at the display of the called party when the subscriber calls the called party in the single country.

In some embodiments of the method, the user interface provides the user with a selection icon for each of the several MSISDNs for the single country from which to choose from.

In some embodiments, the method further displays at the display of the called party a chosen MSISDN for the single country when the subscriber makes a phone call or sends an SMS to a country for which the subscriber did not purchase an MSISDN.

In some embodiments of the method, there can only be one selected country activated in the user interface.

In some embodiments of the method, the subscriber in an advanced mode can select any MSISDN from a list of purchased MSISDNs when making an outgoing call or sending an SMS message to any country.

In some embodiments of the method, the subscriber can remotely select their preference of MSISDN for display when making an outgoing call or sending an SMS message by contacting a call center.

In some embodiments of the method, the subscriber can remotely select their preference of MSISDN for display when making an outgoing call or sending an SMS message by contacting a call center that has access via an application program interface to a billing system and wherein all MSISDNs purchased by the subscriber is stored in a database for the billing system or a separate database.

In some embodiments of the method, the subscriber chooses a preferred MSISDN from a list of purchased MSISDNs to be displayed on the screen of the called party and wherein information about the selected preferred MSISDN is transmitted as an attribute from a mobile application or a Personal Account via a network and via API to the selected billing database, as well as to the multinumbers control point.

In some embodiments, of the method, a selected billing database and the multinumber control point log selected MSISDN(s) made by the subscriber as number attributes and wherein while a connection is being established or when an SMS is being sent, the multinumber control point analyzes the number attributes for the MSISDN and the corresponding calling line identification (CLI) numbers are transmitted based on the number attributes and multinumber control point logic.

### BRIEF DESCRIPTION OF DRAWINGS

The accompanying drawings are incorporated herein and form a part of the specification.

FIG. 1 illustrates a user interface on a mobile application or personal account for a calling line identification display control that interacts with a multinumbers control point in accordance with the embodiments.

FIG. 2 illustrates another user interface for the calling line identification control in accordance with the embodiments (example 1).

FIG. 3 illustrates another user interface for the calling line identification control in accordance with the embodiments (example 2).

FIG. 4 illustrates a database string of a subscriber including subscriber MSISDNs and their respective attributes in accordance with the embodiments.

FIG. 5 illustrates a block diagram and flow for a calling line identification control system that interacts with a multinumbers management technology system in accordance with the embodiments.

In the drawings, like reference numbers generally indicate identical or similar elements. Additionally, generally, the left-most digit(s) of a reference number identifies the drawing in which the reference number first appears.

### DETAILED DESCRIPTION

Multinumbers technology is a unique solution that allows subscribers to add and use an unlimited amount of local and international phone numbers (MSISDNs) on a single SIM card/eSIM, which enables every subscriber “to be local” anywhere. All phone numbers (MSISDNs) are always active for calls and SMS, so the subscriber can enjoy communicating, texting, using the internet, and accessing all the apps or applications they need.

The Multinumbers technology empowers subscribers to become “digital world citizens”. By connecting all the international phone numbers (MSISDNs) to a single SIM card/eSIM and setting up notifications, the subscriber can always stay up to date on all their activities in other countries without being tied to a single physical location. The subscriber can stay in contact with their clients, banks, government agencies, new and existing business partners as if they never left their home country. Regardless of what country the subscriber resides in, they can live like a local no matter where they currently reside.

Multinumbers technology can provide unparalleled convenience to subscribers by offering easy access to an unlimited amount of local and international phone numbers. (MSISDNs) on a single SIM card/eSIM. Thus, the Subscriber does not need to change or switch SIM cards/eSIM with a new number every time the Subscriber arrives in a new country or region to make or receive calls or to send or receive SMS messages from foreign contacts, as well as to use data abroad.

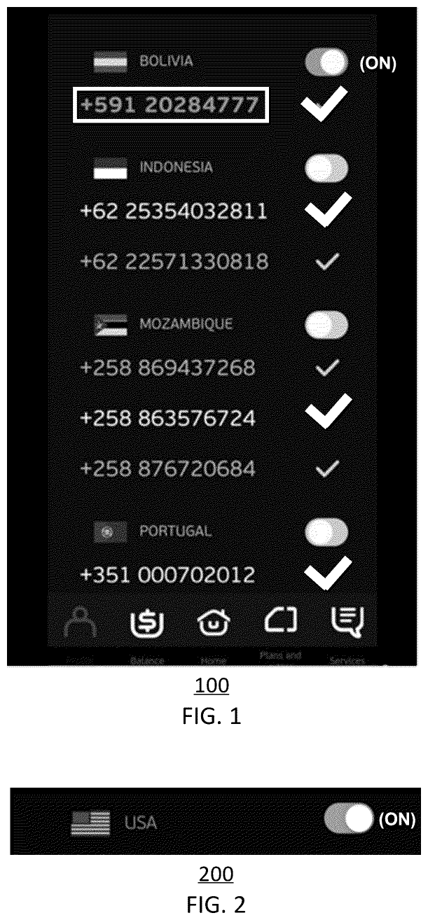

The mechanism of the Multinumbers technology as further detailed below and in FIGS. 1-4 ensures the highest quality of communication, enhances flexibility in communications, eliminates borders between countries, turning one's mobile phone into a truly global digital assistant. This allows any user to enjoy unlimited convenience, saving time and resources.

The innovative Multinumbers solution offers unlimited local and international phone numbers (MSISDNs) and allows users to select their preferred number type for their SIM card/eSIM. These number types include mobile (with SMS support) or landline (without SMS support), geographic (tied to a specific region/city/location in the country) or national (works throughout the country in any region), virtual, or toll-free numbers. If a legal entity subscribes to the service, the wide range of number options provided can enhance the company's reputation and improve customer care.

Multinumbers technology includes essentially an unlimited number of local phone numbers within one country. The subscriber can add an unlimited amount of local numbers in one country. That is, if the subscriber wishes to add more than 2 (two) US numbers, for example, to one SIM card/eSIM, the unique Multinumbers technology allows them to seamlessly use all their connected local numbers for calls and SMS messaging simultaneously.

Number Management Technology as presented herein is an exclusive solution that allows users to manage an unlimited amount of local and international numbers (MSISDNs) on a single SIM card/eSIM, which provides each user with the «local presence effect». Number Management is carried out through an automatic system that allows the subscriber to use the Smart Caller ID service, which displays the local number of the country the subscriber calls or sends an SMS to.

The Number Management technology is indeed a significant step forward in the field of mobile number management (MSISDNs). It not only provides the user with the ability to use numerous local and international phone numbers (MSISDNs) on a single SIM card or eSIM without limits, but also makes the management process as simple and convenient as possible.

Subscribers can use this innovative technology through the mobile application or through their Personal Account on the official website. In addition, the administration of permanently active numbers (MSISDNs) is also possible remotely, when the subscriber calls the call center.

The purpose of the developed Number Management technology is to ensure uninterrupted convenience in managing an unlimited amount of local and international phone numbers (MSISDNs) on a single SIM card/eSIM. The ability to activate and simultaneously use several numbers (MSISDNs), while maintaining cost-effectiveness and efficiency, creates a unique situation in which the «local presence effect» becomes a reality.

The mobile application and Personal Account serve as convenient tools for integrating and managing phone numbers (MSISDNs), allowing users to quickly adapt to changes, as well as focus on the strategic development of their business. This saves time for solving more important issues, minimizing delays that may occur in the process of traditional number management.

Thus, the innovative Number Management technology and related tools represent not only a technological innovation, but also an important business alliance for companies seeking effective communication management and resource optimization. In addition, the Number Management functionality increases flexibility in daily communication for any user, which allows them to feel unlimited convenience in communication, regardless of the subscriber's location.

The interface for either the mobile application or personal account can generally look the same. The interface of the mobile application, as well as the Personal Account, is user-friendly, allowing the user to quickly add, delete and manage phone numbers (MSISDNs). Users can independently select and configure which local number will be displayed to the subscriber during calls and SMS. The number management page in the mobile application or Personal Account can appear as shown in the user interface 100 of FIG. 1. In this example, the Subscriber purchased phone numbers of different countries (Bolivia, Indonesia, Mozambique, and Portugal and has multiple numbers in Indonesia and Mozambique). The default number that the subscriber has selected as the primary number for each country is indicated by a bolded check mark or tick mark. If the subscriber makes a call to the numbers of countries that are not on the list of numbers purchased by the subscriber (MSISDNs), the default number with the selected button in the “ON” position will displayed on the called party's device shown in the white rectangle. Note that the use of buttons and checkmarks or ticks are merely shown as examples and that other ways of designating or representing actuation or selection of functions are contemplated within the scope of the embodiments. For example, different colors for the text or buttons can also represent different activation states for each of the MSISDNs or phone numbers.

The functionality of the automatic Number Management system will generally depend on what a subscriber has purchased in terms of phone numbers and in what countries. Here are various scenarios and how the system would operate under such scenarios:

A. The Subscriber has purchased only one number (MSISDN) of one country (for example, a US number). When the subscriber makes outgoing calls/SMS to any phone number (MSISDNs) in any country, the US number will ALWAYS be displayed on the phone screen of the receiving party.)

B. The Subscriber has phone numbers of different countries (MSISDNs).

When a subscriber makes an outgoing call or sends an SMS to the countries which numbers (MSISDNs) they have purchased, the local number (MSISDN) of the receiving country will ALWAYS be displayed on the phone screen.

When an outgoing call is made/SMS is sent to the numbers of countries that are not on the list of numbers purchased by the subscriber (MSISDNs), the default number of the country that the subscriber has selected as a primary number will ALWAYS be displayed on the phone screen of the receiving party. If the subscriber wants to change the phone number (MSISDN) to be displayed by the receiving party for making outgoing calls and sending SMS to numbers of countries that are not on the list of numbers purchased by the subscriber (MSISDNs), the subscriber can do this independently in the mobile application or in their Personal Account. To do this, the subscriber needs to switch the slider to the ON position opposite the country name as shown in the user interface 200 of FIG. 2 or, alternatively, contact the call center.

In one example the subscriber has purchased the phone numbers from three countries—the UAE, the USA, and the UK. When making an outgoing call/sending an SMS to any US number (+1), the US number of the subscriber will ALWAYS be displayed on the phone screen of the receiving party. When calling/sending an SMS to any number in Great Britain (+44), the UK phone number of the subscriber will be displayed on the screen of the receiving party.

If the Subscriber calls or sends an SMS, for example, to Nigeria, the country which number he does not have, one of the three numbers selected by the Subscriber in the mobile application will be displayed on the phone screen of the receiving party. This may be the number of the UAE, USA or the UK, selected and switched earlier to the ON position opposite the country name.

C. The subscriber has 2 or more phone numbers (MSISDNs) of one country. In the mobile application or in the Personal Account, the subscriber can independently choose which of several numbers (MSISDNs) of one country will be displayed to the receiving party during an outgoing call/SMS to phone numbers of this country.

### EXAMPLE

The subscriber purchased phone numbers of three countries—the USA, Hong Kong and Italy. Specifically, the subscriber purchased two different US numbers and one number each for Hong Kong and Italy. Thus, when calling or sending an SMS to any US number (+1), subscriber's preferred US number selected in the mobile application/Personal Account will ALWAYS be displayed on the receiving party's phone screen (you need to put a tick or check mark in bold next to the selected phone number in one country in this example). When an outgoing call is made or SMS is sent to any Italian number (+39), subscriber's Italian number will be displayed on the phone screen of the receiving party. As discussed before, for outgoing calls or SMS messages sent to countries corresponding to the MSISDN(s) not purchased by the subscriber, the primary default number checked in bold (as indicated by the number in the white rectangle) gets displayed on the phone screen of the receiving party.

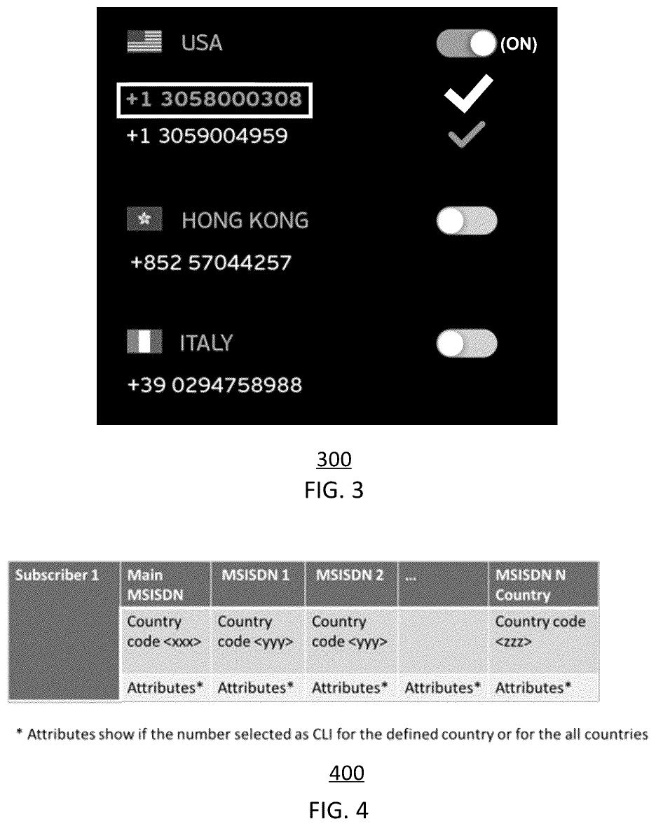

When calling or sending an SMS to a country which number the subscriber does not have (for example, Germany), the number selected by the subscriber in the mobile application or in the Personal Account will ALWAYS be displayed on the receiving party's phone screen (to select a country, you need to turn on the ON position opposite the selected country, and also put a “tick” or bold check opposite the preferred number, if there are two or more numbers of one country). See user interface 300 of FIG. 3.

D. Additional terms for the interface in the subscriber has 2 or more phone numbers (MSISDNs) of one country. There cannot be more than one selected country marked in the ON position in the mobile application or in the subscriber's Personal Account. For example, if the subscriber activates the UK number, the US number is automatically deactivated.

If the subscriber has more than one number (MSISDN) of a certain country, for example the USA, then the subscriber can select a priority number for this country, REGARDLESS of whether the ON position is set opposite another country in the mobile application or in the Personal Account.

Functionality of the automatic Number Management system. When making an outgoing call/sending an SMS to any country, the subscriber has the opportunity to select any number (MSISDN) from the list of purchased ones.

That is, regardless of where the subscriber is physically located and it does not matter where the subscriber calls or sends an SMS, the receiving party will always display the phone number (MSISDN) that the subscriber activated in the mobile application or in their Personal Account.

The subscriber's preferred phone number of any country (from the list of purchased phone numbers) can always be activated for each call or when sending an SMS. If the subscriber chooses to display different phone numbers (MSISDNs) every time they make a call or send an SMS, then the subscriber needs to switch the phone number to the preferred one in a timely manner in the interface of the mobile application/Personal Account or contact the call center.

This technology strives to provide its customers with maximum convenience, flexibility and security in managing their mobile communication, which is an important aspect of the modern lifestyle.

Remote management of phone numbers (MSISDNs) when the subscriber calls the call centre. Permanently active phone numbers (MSISDNs) can be managed remotely, when the subscriber calls the call centre. In this case, the Subscriber does not need to manage his/her phone numbers (MSISDNs) in the mobile application or in the Personal Account. Call centre employees help the subscriber remotely select the automatic display of different phone numbers for each call or SMS.

Call centre, using Number Management technology, quickly responds to user requests in real time and provides personal service to each subscriber. This significantly speeds up the service process and increases customer satisfaction.

In addition, automation and centralized control over phone numbers (MSISDNs) help to avoid errors that may occur with manual management. The innovative system reduces the workload of the call centre, allowing the employees to focus on important aspects of customer service.

Additional benefits of the mobile application and Personal Account. The mobile application and Personal Account are also regularly updated, new functions are added to the interface based on user feedback. This allows us to stay on the cutting edge of modern digital communication, providing our subscribers with the most up-to-date tools for effective communication in any conditions. The established communication ecosystem makes Number Management technology an ideal solution for both private users and businesses seeking to optimize their communication processes.

It should be noted that the Number Management system (MSISDNs) meets modern security requirements. Access to settings is limited and controlled, which minimizes the risks of unauthorized access to subscriber data. This fosters trust between the company and its customers, that is quite crucial in the rapidly changing digital world.

Thus, effective administration of phone numbers (MSISDNs) not only simplifies interaction with subscribers, but also strengthens corporate values aimed at the quality and security of the services provided.

Number Management technology is implemented through the mobile application, Personal Account or call centre operator who has access via API (Application Program Interface) to the billing system.

All the phone numbers the subscriber has purchased are stored in the billing system's database or a separate database at the discretion of the telecom operator. Phone numbers (MSISDNs) are entered into the selected database as they are purchased by the subscriber.

A telecom operator having its own range of MSISDNs stores all MSISDNs of its subscribers in the selected database. If the subscriber wishes to have several phone numbers from the range of MSISDNs provided by their operator or from the range of phone numbers of other countries, then additional phone numbers will be added to the main MSISDN in the operator's database. FIG. 1 shows an example of a database row for a single subscriber with a set of his numbers. Each number (MSISDN) contains Country code. This element is used by the Multinumber Control Point to determine CLI selection mechanism.

The Multinumber Control Point mechanism is detailed in the U.S. patent application Ser. No. 18/891,576 filed on Sep. 20, 2024 entitled “Multinumbers Technology for Wireless Services” by the Applicant and Assignee herein and hereby incorporated by reference.

See chart 400 in FIG. 4 for an example of a data base string for a subscriber.

When the subscriber uses the Number Management function in the mobile application or Personal Account, the selected database is accessed via the Internet and API. In response to this request, the database returns a set of up-to-date numbers (MSISDNs) of the subscriber and their attributes (statuses)—see Section 3.

Then the subscriber can choose the preferred number (MSISDN) from the list of his numbers (MSISDNs) to be displayed on the screen of the subscriber B.

The information about this selection is transmitted for the corresponding number (MSISDN) as an attribute from the mobile application or Personal Account via the Internet and via API to the selected billing database, as well as to the Multinumber Control Point.

If the subscriber contacts the call centre to choose the preferred number (MSISDN) to be displayed on the screen of subscriber B, then the call center employee enters the relevant information which is then relayed to the selected billing database, as well as the Multinumber Control Point.

The selected billing database and the Multinumber Control Point log the phone number selection (MSISDN(s)) made by the subscriber as number attributes.

While the connection is being established/SMS is being sent, Multinumber Control Point analyzes number attributes (MSISDNs); the corresponding CLI numbers are transmitted based on these attributes and the Multinumber Control Point mechanism.

In addition, the selecting billing database ensures long-term storage of all numbers (MSISDNs), change record of numbers (MSISDNs) and its attributes, as well as all the information about numbers'(MSISDNs) usage (calls, SMS, etc.)

The selected billing database and the Multinumber Control Point store numbers (MSISDNs) of only active subscribers; as far as the subscribers who don't often use the Number Management functionality are concerned, the Multinumber Control Point requests the information about numbers (MSISDNs) and its attributes from the selected billing database, while the API ensures the connection between different systems and serves as the interface for connecting to the billing database and the Multinumber Control Point.

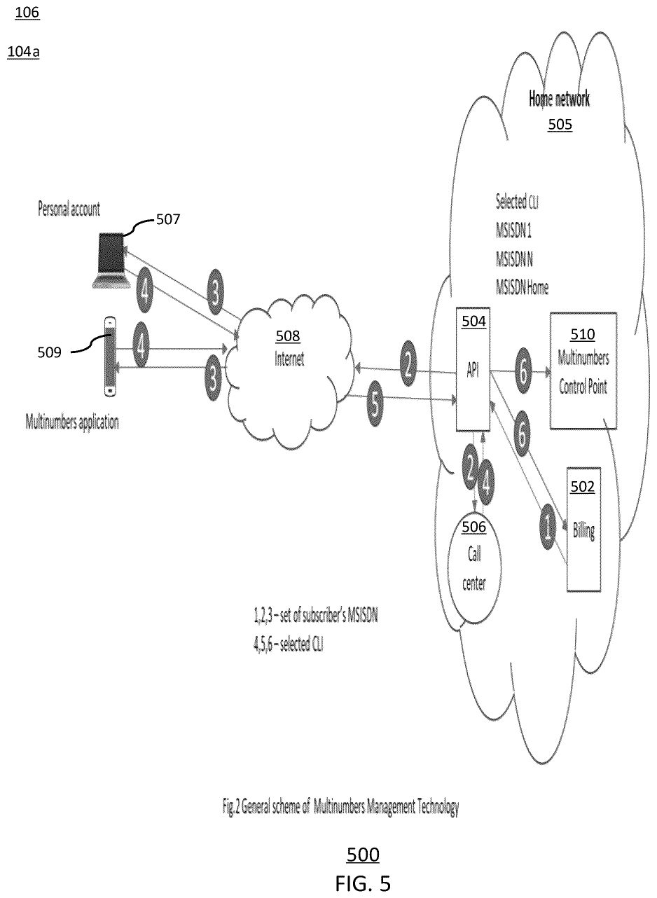

A system 500 in FIG. 5 shows how the information about the subscriber's numbers (MSISDNs) is transmitted from a billing database 502 to a mobile application on a subscriber device like a mobile phone 509, or to a Personal Account at a call center operator 506, as well as how the information about the number selected by the subscriber (MSISDN) is relayed from the mobile application, Personal Account or the call center operator via the Internet 508 and an API 504 to the billing database 502 and a Multinumber Control Point 510 as shown.

When opening the mobile application (509), Personal Account (accessable via a client device such as a personal computer 507), or call center (506) interface, the billing database 502 receives information via the API 504 about the subscriber's available numbers (MSISDNs) and their current displayed number (during steps 1,2, and 3) as shown.

When the subscriber enters the information about the selected number (MSISDN), this information is transmitted from the mobile application (509), Personal Account (507), or call center (506) operator interface via the API 504 to the billing database 502 and the Multinumber Control Point 510 (during steps 4,5, and 6) as shown.

The Multinumber Control Point 510 implements the numbers (MSISDN) display mechanism in either a standard mode having set rules for displaying CLIs or an advance mode where the subscriber can essentially override the standard mode and display their desired CLI for any call or SMS message to any country.

When the standard mode is enabled, the Multinumber Control Point 510 provides the number of the calling party based on the number (and country) of the called party. When the advance mode is in place, the Multinumber Control Point 510 provides the number of the calling party in accordance with the primary number selected by the subscriber, regardless of the number (and country) of the called party.

The Multinumber Control Point 510 ensures the transmission of the relevant CLI across all systems involved in establishing a connection or transmitting SMS.

In the absence of any specific clarification related to its express use in a particular context, where the terms “substantial ” or “about ” in any grammatical form are used as modifiers in the present disclosure and any appended claims (e.g., to modify a structure, a dimension, a measurement, or some other characteristic), it is understood that the characteristic may vary by up to 30 percent. For example, a small cell networking device may be described as being mounted “substantially vertical,” In these cases, a device that is mounted exactly vertical is mounted along a “Y” axis and a “X” axis that is normal (i.e., 90 degrees or at right angle) to a plane or line formed by a “Z” axis. Different from the exact precision of the term, “vertical,” and the use of “substantially” or “about ” to modify the characteristic permits a variance of the particular characteristic by up to 30 percent.

The terms “include” and “comprise” as well as derivatives thereof, in all of their syntactic contexts, are to be construed without limitation in an open, inclusive sense, (e.g., “including, but not limited to”). The term “or,” is inclusive, meaning and/or. The phrases “associated with” and “associated therewith,” as well as derivatives thereof, can be understood as meaning to include, be included within, interconnect with, contain, be contained within, connect to or with, couple to or with, be communicable with, cooperate with, interleave, juxtapose, be proximate to, be bound to or with, have, have a property of, or the like.

Unless the context requires otherwise, throughout the specification and claims which follow, the word “comprise” and variations thereof, such as, “comprises” and “comprising,” are to be construed in an open, inclusive sense, e.g., “including, but not limited to.”

Reference throughout this specification to “one embodiment” or “an embodiment” or “some embodiments” and variations thereof means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content and context clearly dictates otherwise. It should also be noted that the conjunctive terms, “and” and “or” are generally employed in the broadest sense to include “and/or” unless the content and context clearly dictates inclusivity or exclusivity as the case may be. In addition, the composition of “and” and “or” when recited herein as “and/or” is intended to encompass an embodiment that includes all of the associated items or ideas and one or more other alternative embodiments that include fewer than all of the associated items or idea.

In the present disclosure, conjunctive lists make use of a comma, which may be known as an Oxford comma, a Harvard comma, a serial comma, or another like term. Such lists are intended to connect words, clauses or sentences such that the thing following the comma is also included in the list.

As the context may require in this disclosure, except as the context may dictate otherwise, the singular shall mean the plural and vice versa. All pronouns shall mean and include the person, entity, firm or corporation to which they relate. Also, the masculine shall mean the feminine and vice versa.

When so arranged as described herein, each computing device may be transformed from a generic and unspecific computing device to a combination device comprising hardware and software configured for a specific and particular purpose. When so arranged as described herein, to the extent that any of the inventive concepts described herein are found by a body of competent adjudication to be subsumed in an abstract idea, the ordered combination of elements and limitations are expressly presented to provide a requisite inventive concept by transforming the abstract idea into a tangible and concrete practical application of that abstract idea.

The headings and abstract provided herein are for convenience only and do not limit or interpret the scope or meaning of the embodiments. The various embodiments described above can be combined to provide further embodiments. Aspects of the embodiments can be modified, if necessary to employ concepts of the various patents, application and publications to provide yet further embodiments.

Based on the teachings contained in this disclosure, it will be apparent to persons skilled in the relevant art(s) how to make and use embodiments of this disclosure using data processing devices, computer systems and/or computer architectures other than that shown in FIG. 4. In particular, embodiments can operate with software, hardware, and/or operating system implementations other than those described herein.

Embodiments of the present disclosure have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments but should be defined only in accordance with the following claims and their equivalents.

What is claimed:

1. A calling line identification display control system that interacts with a multinumbers control point in a home network and further having one or more subscriber phone numbers stored on a memory of the multinumbers control point, comprising:
a user interface enabling a subscriber to independently select and configure which Mobile Station Integrated Services Digital Number (MSISDNs) will be displayed to a called party during a phone call or a short messaging system (SMS) calls; and
one or more processors coupled to the memory having computer instructions, the one or more processors configured to execute computer instructions to perform the operations of:
always displaying a primary number on the display of the called party when the subscriber makes outgoing calls or sends SMS messages to any MSISDN in any country and when the subscriber has purchased only the primary number;
when the subscriber makes outgoing calls or sends SMS messages and when the subscriber has multiple MSISDNs in different countries that were purchased, displaying a local number (MSISDN) of a receiving country on the display of the called party; and
when the subscriber makes outgoing calls or sends SMS messages to MSISDNs in countries not on a list of numbers purchased by the subscriber, displaying a default number of a country that the subscriber selected as the primary number on the display of the called party.

2. The calling line identification display control system of claim 1, wherein the one or more processors are further configured to enable the subscriber to independently choose among several MSISDNs for a single country for display at the display of the called party when the subscriber calls the called party in the single country.

3. The calling line identification display control system system of claim 2, wherein the user interface provides the user with a selection icon for each of the several MSISDNs for the single country from which to choose from.

4. The calling line identification display control system system of claim 2, wherein the system displays at the display of the called party a chosen MSISDN for the single country when the subscriber makes a phone call or sends an SMS to a country for which the subscriber did not purchase an MSISDN.

5. The calling line identification display control system system of claim 1, wherein there can only be one selected country activated in the user interface.

6. The calling line identification display control system system of claim 1, wherein the subscriber in an advanced mode can select any MSISDN from a list of purchased MSISDNs when making an outgoing call or sending an SMS message to any country.

7. The calling line identification display control system system of claim 1, wherein the subscriber can remotely select their preference of MSISDN for display when making an outgoing call or sending an SMS message by contacting a call center.

8. The calling line identification display control system system of claim 1, wherein the subscriber can remotely select their preference of MSISDN for display when making an outgoing call or sending an SMS message by contacting a call center that has access via an application program interface to a billing system and wherein all MSISDNs purchased by the subscriber is stored in a database for the billing system or a separate database.

9. The calling line identification display control system system of claim 1, wherein the subscriber chooses a preferred MSISDN from a list of purchased MSISDNs to be displayed on the screen of the called party and wherein information about the selected preferred MSISDN is transmitted as an attribute from a mobile application or a Personal Account via a network and via API to the selected billing database, as well as to the multinumbers control point.

10. The calling line identification display control system system of claim 9, wherein a selected billing database and the multinumber control point log selected MSISDN(s) made by the subscriber as number attributes and wherein while a connection is being established or when an SMS is being sent, the multinumber control point analyzes the number attributes for the MSISDN and the corresponding calling line identification (CLI) numbers are transmitted based on the number attributes and multinumber control point logic.

11. A method for calling line identification display control that interacts with a multinumbers control point in a home network and where one or more subscriber phone numbers are stored on a memory of the multinumbers control point, comprising the steps of:
presenting a user interface enabling a subscriber to independently select and configure which Mobile Station Integrated Services Digital Number (MSISDNs) will be displayed to a called party during a phone call or a short messaging system (SMS) calls;
always displaying a primary number on the display of the called party when the subscriber makes outgoing calls or sends SMS messages to any MSISDN in any country and when the subscriber has purchased only the primary number;
when the subscriber makes outgoing calls or sends SMS messages and when the subscriber has multiple MSISDNs in different countries that were purchased, displaying a local number (MSISDN) of a receiving country on the display of the called party; and
when the subscriber makes outgoing calls or sends SMS messages to MSISDNs in countries not on a list of numbers purchased by the subscriber, displaying a default number of a country that the subscriber selected as the primary number on the display of the called party.

12. The method of calling line identification display control of claim 11, further configuring the user interface to enable the subscriber to independently choose among several MSISDNs for a single country for display at the display of the called party when the subscriber calls the called party in the single country.

13. The method of calling line identification display control of claim 12, wherein the user interface provides the user with a selection icon for each of the several MSISDNs for the single country from which to choose from.

14. The method of calling line identification display control of claim 12, wherein the method further displays at the display of the called party a chosen MSISDN for the single country when the subscriber makes a phone call or sends an SMS to a country for which the subscriber did not purchase an MSISDN.

15. The method of calling line identification display control of claim 11, wherein there can only be one selected country activated in the user interface.

16. The method of calling line identification display control of claim 11, wherein the subscriber in an advanced mode can select any MSISDN from a list of purchased MSISDNs when making an outgoing call or sending an SMS message to any country.

17. The method of calling line identification display control of claim 11, wherein the subscriber can remotely select their preference of MSISDN for display when making an outgoing call or sending an SMS message by contacting a call center.

18. The method of calling line identification display control of claim 11, wherein the subscriber can remotely select their preference of MSISDN for display when making an outgoing call or sending an SMS message by contacting a call center that has access via an application program interface to a billing system and wherein all MSISDNs purchased by the subscriber is stored in a database for the billing system or a separate database.

19. The method of calling line identification display control of claim 11, wherein the subscriber chooses a preferred MSISDN from a list of purchased MSISDNs to be displayed on the screen of the called party and wherein information about the selected preferred MSISDN is transmitted as an attribute from a mobile application or a Personal Account via a network and via API to the selected billing database, as well as to the multinumbers control point.

20. The method of calling line identification display control of claim 19, wherein a selected billing database and the multinumber control point log selected MSISDN(s) made by the subscriber as number attributes and wherein while a connection is being established or when an SMS is being sent, the multinumber control point analyzes the number attributes for the MSISDN and the corresponding calling line identification (CLI) numbers are transmitted based on the number attributes and multinumber control point logic.
